(19) United States
(12) Patent Application Publication
(10) Pub. No.: US 2006/0221078 A1
(43) Pub. Date: Oct. 5, 2006

(54) Method for comparing semiconductor characteristic curves

(75) Inventor: Koji Ishizuka, Tokyo (JP)

Correspondence Address: Paul D. Greeley;Ohlandt, Greeley, Ruggiero & Perle, L.L.P., 10 Floor, One Landmark Square, Stamford, CT, 06901-2682, US

(73) Assignee: Agilent Technologies, Inc.

(21) Appl. No.: 11/392,437

(22) Filed: Mar. 29, 2006

(30) Foreign Application Priority Data
Mar. 30, 2005 (JP) 2005-098431

(51) Int. Cl. G06T 11/20

(52) U.S. Cl. 345/440

(57) ABSTRACT

An analysis system includes a storage device for storing semiconductor-device measurement results and a graph display program; a display for displaying the measurement results in graphs in windows; input device for selecting some of the windows; and a processor for superimposing and displaying the graphs in the windows, by using the graph display program, so that only a display area of the graph in one of the windows selected by the input device, the one window being located at the topmost layer displayed by the display, is made transparent, an area other than the display area of the graph is made opaque, at least a display area of the graph located in the window displayed at the bottommost layer is made opaque, and at least a display area of the graph in the window located at a layer between the topmost layer and the bottommost layer is made transparent.

### BACKGROUND OF THE INVENTION

1. Field of the Invention

The present invention relates to, in a semiconductor-characteristic evaluation apparatus, a method, a system and a computer program product for displaying measurement results, obtained by the measurement and evaluation of semiconductor devices, as graphs.

2. Description of the Related Art

In conventional semiconductor-characteristic evaluation apparatuses, a wafer-map analysis aid system or the like is used to numerically manage whether measurement and evaluation results of semiconductor devices fall within a certain range. Making a determination based only on whether or not the results are within the numeric ranges makes it difficult to take measures before an alarm is displayed when an abnormality occurs. This may cause an adverse effect, such as a decrease in the yield.

In order to overcome such problems, Japanese Unexamined Patent Application Publication No. 11-67853 discloses a wafer-map analysis aid method and system. In this patent document, fabrication tolerances and the likelihood of troubles, such as failures specific to a manufacturing apparatus, a sign of breakdown, or a mask-induced malfunction that can occur during a model change, are estimated using wafer maps in the manufacturing process. Specifically, a composite map is created from the original map for some wafer maps, is displayed on an image display, and coloration, including the degree of transparency, is set with respect to each wafer map, so that information can be distinguished when wafer maps are superimposed on one another. The above-mentioned publication also discloses schemes in which, for example, the coloration setting can be changed on a map combining screen and the wafer maps can be moved up and down between the layers thereof.

Such schemes, however, have the following restrictions. First, only global adjustment is suggested for the degrees of transparency of the entire backgrounds in displayed wafer-map graphs for indicating semiconductor-device characteristics. That is, in the case of an XY plane graph, the conventional technology is not intended to selectively adjust the coloration in each graph area (i.e., in a display area) surrounded by the X and Y axes of the graph. Thus, even when it is desirable to superimpose some graphs showing semiconductor-device characteristics for easy comparison, relevant data processing is required before data can be displayed in one graph. This makes it difficult to perform prompt observation.

### SUMMARY OF THE INVENTION

The present invention allows characteristics of semiconductor devices to be readily compared in order to make the measurement results of semiconductor devices and tendencies specific to a manufacturing apparatus immediately understandable.

The present invention provides an analysis system that allows a user to readily and visually compare and understand, on a display screen, semiconductor-device measurement results and tendencies specific to a manufacturing apparatus.

Specifically, the present invention provides an analysis system for semiconductor-device measurement results. The analysis system includes: a storage device for storing semiconductor-device measurement results and a graph display program; a display for displaying the measurement results in graphs in individual windows; and input device for selecting some of the windows. The analysis system further includes a processor for superimposing and displaying the graphs in the windows on the display, by using the graph display program, so that only a display area of the graph in one of the windows selected by the input device, the one window being located at the topmost layer displayed by the display, is made transparent, an area other than the display area of the graph is made opaque, at least a display area of the graph located in the window displayed at the bottommost layer is made opaque, and at least a display area of the graph in the window located at a layer between the topmost layer and the bottommost layer is made transparent.

Preferably, when the size of a first one of the graphs in the windows is changed using the input device, the processor further performs processing so that the graphs in the other windows have the same size as the first graph, based on a scale ratio of the changed first graph. Preferably, the storage device further includes a rendering-information sharing section that stores information on the types of graphs displayed in the selected windows. Preferably, the type of graph is an XY plane drawing, a scatter chart, or a radar chart.

The present invention further provides an analysis method that allows a user to readily and visually compare and understand, on a display screen, semiconductor-device measurement results and a tendency specific to an apparatus.

Specifically, the present invention provides an analysis method for semiconductor-device measurement results. The analysis method includes a storing step of storing semiconductor-device measurement results and a graph display program; a displaying step of displaying the measurement results in graphs in individual windows; and an inputting step of selecting some of the windows. The analysis method further includes a computing step of superimposing and displaying the graphs in the windows, by using the graph display program, so that only a display area of the graph in one of the windows selected in the inputting step, the one window being located at the topmost layer displayed in the displaying step, is made transparent, an area other than the display area of the graph is made opaque, at least a display area of the graph located in the window displayed at the bottommost layer is made opaque, and at least a display area of the graph in the window located at a layer between the topmost layer and the bottommost layer is made transparent.

Preferably, when the size of a first one of the graphs in the windows is changed in the inputting step, processing is performed in the computing step so that the graphs in the other windows have the same size as the first graph, based on a scale ratio of the changed first graph. Preferably, the analysis method further includes a step of storing, in a rendering-information sharing section, information on the types of graphs displayed in the selected windows. Preferably, the type of graph is an XY plane graph, a scatter chart, or a radar chart.

The present invention further provides an analyzing computer program that allows a user to readily and visually compare and understand, on a display screen, semiconductor-device measurement results and a tendency specific to an apparatus.

Specifically, the present invention provides a computer program that causes a processor to execute: a command for performing processing so that only a display area of the graph in the window displayed at the topmost layer in the displaying step is made transparent and an area other than the display area is made opaque; a command for performing processing so that at least a display area of the graph in the window displayed at the bottommost layer in the displaying step is made opaque; a command for performing processing so that at least a display area of the graph in the window located at a layer displayed between the topmost layer and the bottommost layer in the displaying step is made transparent; and a command for displaying, in the displaying step, the graphs in the windows and superimposing the graphs so that axes of the graphs are aligned with one another.

Herein, the phrase “same types of graphs” refers to graphs that can be superimposed on one another and that have parameter axes indicating the same physical quantities. Also, the phrase “different types of graphs” refer to types of graphs that are different from each other or graphs that have parameter axes indicating physical quantities different from each other, even if the types of graphs are the same.

According to the present invention, various graphs indicating semiconductor-device measurement results can be displayed with the sizes of the graphs being increased or reduced as well as zoomed and in a superimposed manner or the results can be displayed by arranging the graphs with an offset therebetween. The present invention, therefore, provides an advantage in that it is possible to easily and promptly determine the amount of offset and the tendency of the difference in measurement results.

### BRIEF DESCRIPTION OF THE DRAWINGS

FIG. 1 is a schematic block diagram showing the entire configuration of a semiconductor-measurement-result analysis system for implementing the present invention;

FIG. 2 is a flow chart showing an analysis method using the analysis system shown in FIG. 1;

FIG. 3 is a schematic view showing an example in which semiconductor-device measurement results plotted in an XY plane drawing in one window activated by a user's selection is displayed;

FIG. 4 is a schematic view showing an example in which data in selected windows shown in FIG. 3 are integrally displayed in a graph with reference to data in the active windows shown in FIG. 3;

FIG. 5 is a schematic view showing an example of a case in which one of three windows indicating semiconductor-device measurement results is shifted by a predetermined amount of data; and

FIG. 6 is a schematic view showing an example of a case in which data in the three windows shown in FIG. 5 are shifted by the same amount, as a reference for comparison with FIG. 5.

### DESCRIPTION OF THE PREFERRED EMBODIMENTS

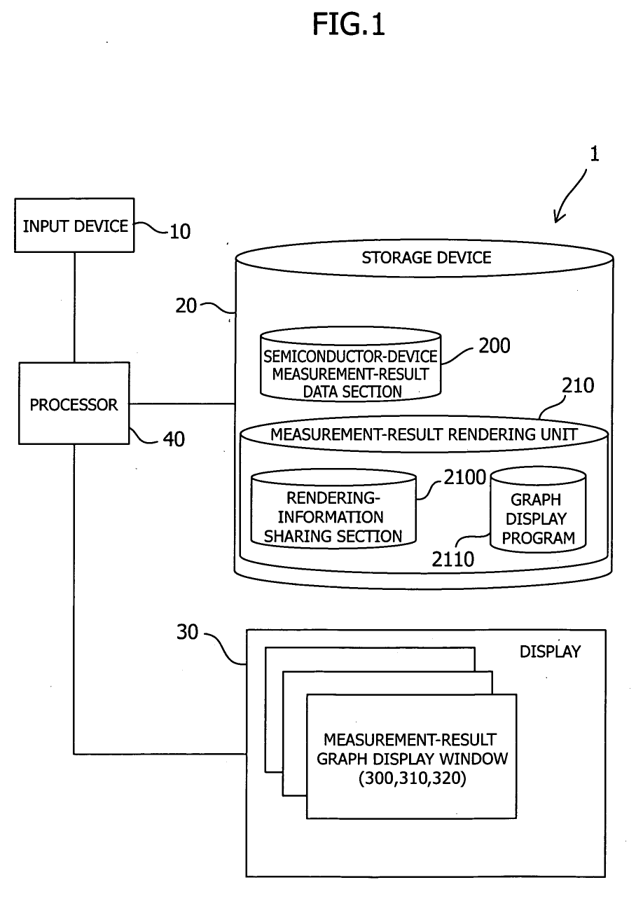

FIG. 1 shows the configuration of an analysis system 1 for measuring and evaluating semiconductor devices, which is used for implementing the present invention. The analysis system 1 includes input device 10, a storage device 20, measurement-result rendering unit (program) 210, a display 30, and a processor 40. The storage device 20 stores measurement results of semiconductor devices. The display 30 displays the measurement results in graphs in individual windows 300, 310, 320 . . . The input device 10 selects some of the windows 300, 310, 320 . . . The measurement-result rendering unit 210 includes a rendering-information sharing section 2100, which stores information on the types of graphs displayed in the windows selected by the input device 10, and a graph display program 2110, which is used to display the measurement results in graphs. Using the graph display program 2110, the processor 40 determines whether or not the types of graphs are the same, based on the information stored in the rendering-information sharing section 2100, and when the types of graphs are the same, the processor 40 automatically equalizes the scale ranges of the graphs displayed in the windows, performs processing so that only the display area of one of the graphs is made transparent and the entire backgrounds of the other graphs are made transparent, causes the display 30 to display the one graph in the window at the topmost layer, and performs processing for superimposing the other graphs under the one graph so that the axes of the other graphs are aligned with the axes of the one graph.

In the analysis system 1 shown in FIG. 1, the storage device 20 includes a data section 200 for semiconductor-device measurement results and the measurement-result rendering unit 210. The present invention, however, is not limited to the illustrated configuration. For example, the semiconductor-device measurement-result data-section 200 and the measurement-result rendering unit 210, which includes the rendering-information sharing section 2100 and the graph display program 2110, may be provided in separate storage devices.

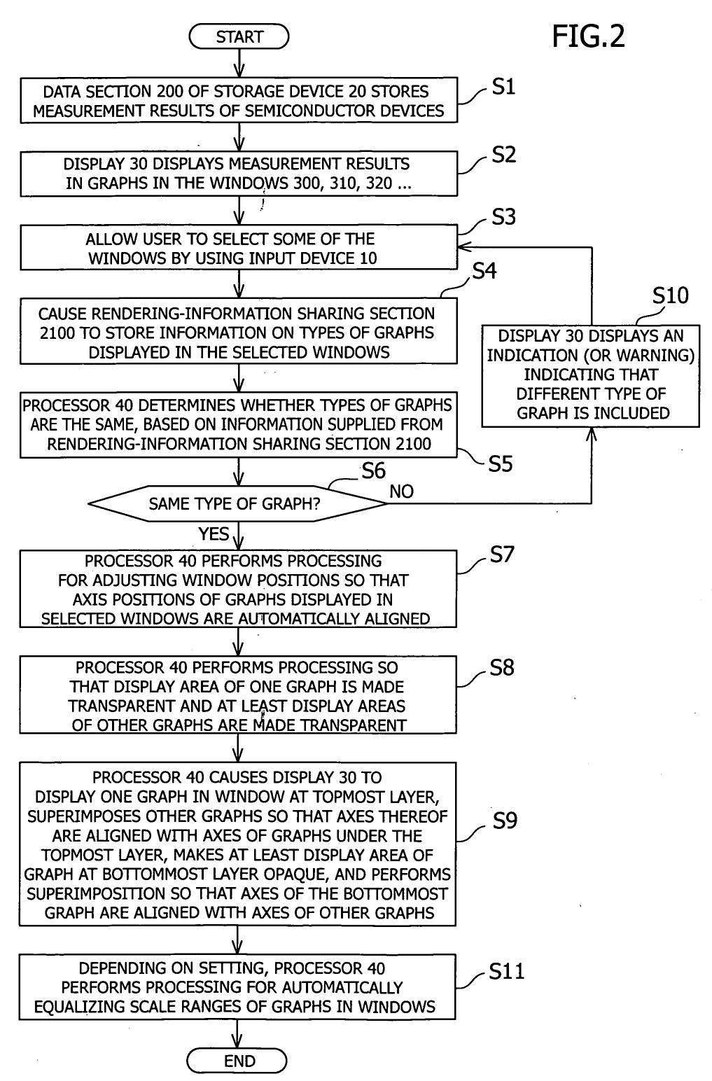

FIG. 2 shows a flow chart of a method for analyzing the measurement results of semiconductor devices, using the analysis system 1 in FIG. 1. An analysis method using the analysis system 1 in FIG. 1 will be briefly described below.

First, in step S1, the measurement results of semiconductor devices are stored in the data section 200 of the storage device 20. In step S2, the display 30 displays the measurement results in graphs within the individual windows 300, 310, and 320 . . . In step S3, using the input device 10, the user selects some of the windows 300, 310, and 320 . . . In step S4, information on the types of graphs displayed in the selected windows is stored in the rendering-information sharing section 2100.

In step S5, based on the information stored in the rendering-information sharing section 2100, the processor 40 determines whether or not the types of graph are the same. In step S6, when the processor 40 determines that the types of graphs are the same, the process proceeds to step S7. In step S7, the processor 40 automatically adjusts the window positions so that the positions of axes of the graphs displayed in the selected windows are superimposed on one another. In step S8, with respect to one of the graphs, the processor 40 performs processing so that only the display area of the one graph is made transparent, and with respect to the other graphs, the processor 40 performs processing so that at least the display areas thereof are made transparent. Next, in step S9, the processor 40 causes the display 30 to display the one graph in the window at the topmost layer and superimposes the other graphs under the topmost layer so that the axes thereof are aligned with the axes of the one graph. Further, with respect to the window at the bottommost layer, the processor 40 makes at least its graph display area opaque and performs superimposition so that axes of the bottommost window are aligned with the axes of the other graphs. Lastly, in step S11, based on the settings, the processor 40 performs processing for automatically equalizing the scale ranges of the graphs in the respective windows and displays the graphs. With this configuration, by selecting some windows on the display 30, the user can more easily superimpose and compare measurement results of semiconductor devices. The “one graph” noted above may be selected by the user, via the input device 10, as a graph indicating a measurement result that serves as a reference for comparison. Such processing performed by the processor 40 is executed using the graph display program 2110 for displaying measurement results in graphs.

On the other hand, when the types of graphs are different from each other, the process proceeds to step S10 in which an indication (or warning) indicating that a different type of graph is included is displayed on the display 30. The process then returns to step S3 so as to allow the user to select an appropriate graph again.

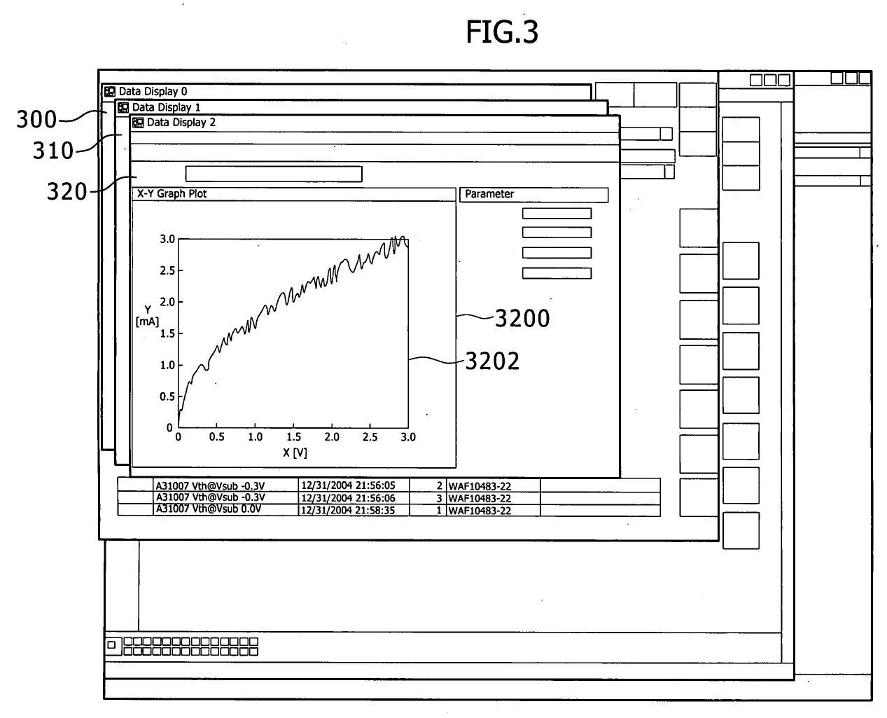

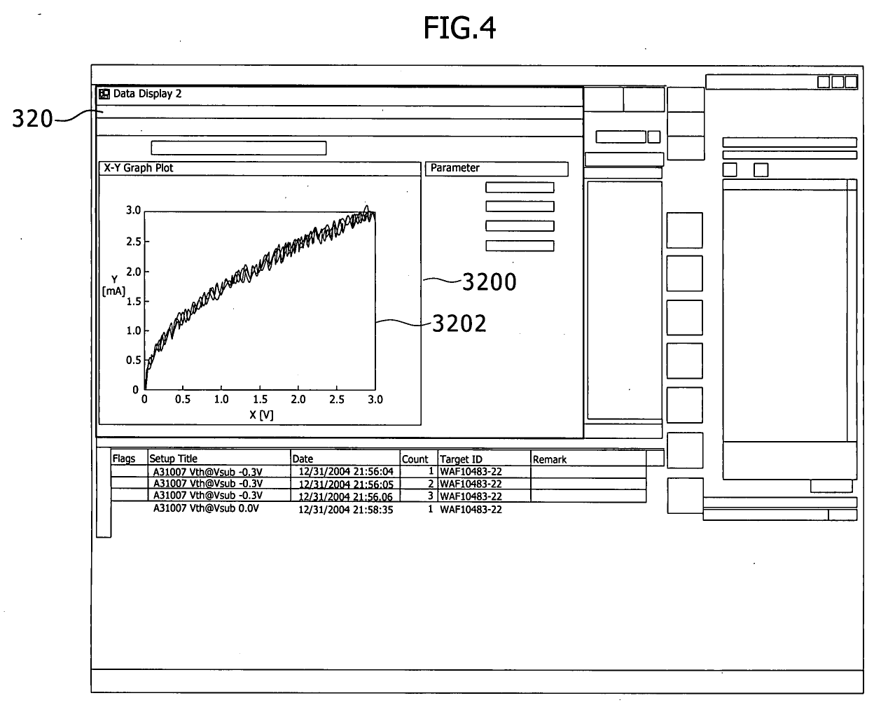

FIGS. 3 and 4 each show one example of an operation screen of the display 30 of the analysis system 1 used for implementing the present invention. Specifically, FIG. 3 shows an example of the display of semiconductor-device measurement results plotted in an XY plane drawing in one window activated by the user's selection, of three windows displayed on the screen of the display 30. FIG. 4 shows an example of display in which the graphs in selected windows shown in FIG. 3 are superimposed with reference to the data shown in the active window. The description given below for FIG. 3 and the subsequent figures is for an example in which the active window 320 is located at the topmost layer on the display 30. The active window, however, does not necessarily have to be displayed at the topmost layer; it may be located at the bottommost layer or may be located between other windows. Optionally, based on the range of data in the active window, the ranges of graphs displayed in the selected windows can be automatically equalized (auto-scaled) to have the same scale ratio and be superimposed on one another.

Next, a display area 3202 of the graph located in the active window 320 will be briefly described with reference to the window 320 shown in FIG. 3. The illustrated window 320 has a first area 3200 for showing an XY plane graph. The first area 3200 includes a second area 3202 surrounded by graph axes. The “display area” of the graph in the present invention refers to the second area 3202. The “display area” not only includes a graph located in an active window, but also includes graphs in selected windows.

A method for operating the analysis system 1 used for implementing the present invention will be briefly described below.

First, using the input device 10 or the like, the user calls up measurement results for comparison on the display 30, so that the measurement results are displayed on some windows. Referring now to the example shown in FIG. 3, three sets of data are selected as the data of semiconductor-device measurement results, XY plane drawings are displayed in the respective windows 300, 310, and 320 corresponding to the data, and the window 320 (i.e., the window denoted by “Data Display 2”) of the windows 300, 310, and 320 is activated. The measurement result and the type of graph displayed in the active window 320 are used as references for comparison with the corresponding measurement results and types of graphs displayed in the other windows 300 and 310.

Next, with the measurement result and the type of graph displayed in the active window 320 being used as references, the graphs are positioned and displayed so that the positions of the axes of the graphs in the other windows 300 and 310 are superimposed on one another. This can be achieved by processing in which the user operates the input device 10 to select a superimposing-command menu or button on the display 30, and based on the selection, the processor 40 uses the rendering-information sharing section 2100 and the graph display program 2110 of the measurement-result rendering unit 210 to perform processing for aligning the axis positions of the graphs in the selected windows 300, 310, and 320. The graphs in the selected windows are automatically resized by the processor 40 so as to correspond to the axis scale and are superimposed as shown in FIG. 4.

In this example, of the scales of the graphs in the windows, the scale of the graph in the active window 320 is displayed. This is achieved by the processor 40 performing processing on the graph in the active window so that only the area bounded by the X and Y axes thereof becomes transparent. The entire background in the window at the bottommost layer or at least the area surrounded by the graph X and Y axes in the window is made opaque. With respect to the other window that is not activated, the processor 40 performs processing so that the entire background in the window or at least the area surrounded by the graph X and Y axes is made transparent. Consequently, as shown in FIG. 4, superimposed measurement results are displayed in the display area 3202 of the graph in the selected window 320. In this case, it can be seen from FIG. 4 that the selected measurement results shown in FIG. 3 exhibit substantially the same behavior.

The graphs in FIG. 4 are plotted in the same color, but the present invention is not limited thereto. For example, the graphs in the windows may be displayed in different colors.

When it is desired to more precisely superimpose and compare the graphs in the windows, there is a need to align the sizes and the positions of the windows and the setting ranges (scale ranges) of the axes of the corresponding graphs. The analysis system 1 used for implementing the present invention can also meet such a requirement, since the measurement-result rendering unit 210 includes the graph display program 2110 that allows the processor 40 to execute the function of automatically adjusting the scale ratios of the graphs (i.e., an autoscaling function) in accordance with a pre-stored desired setting or in response to a command issued from the input device 10 upon reception of an instruction from the user.

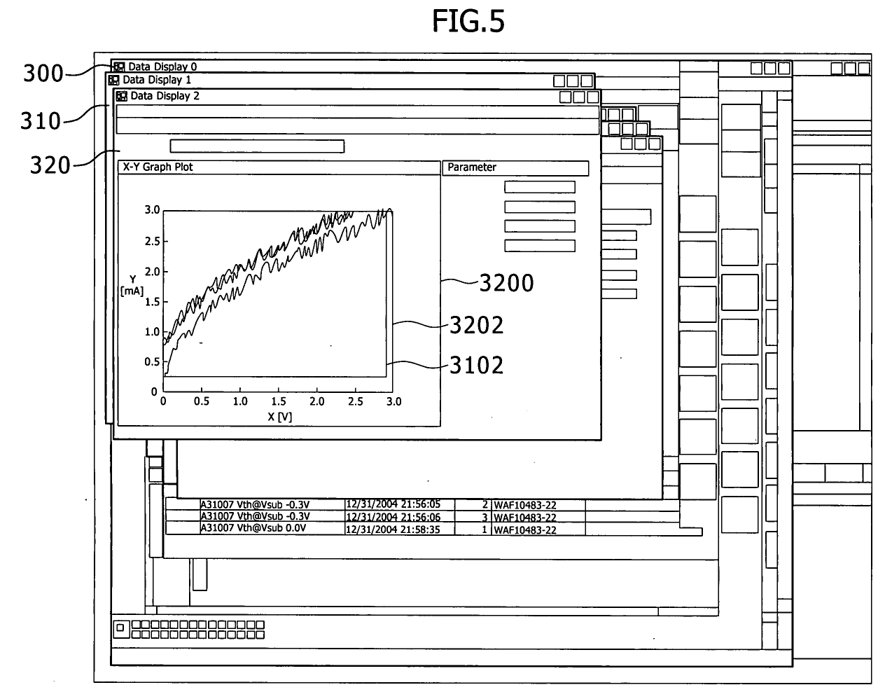

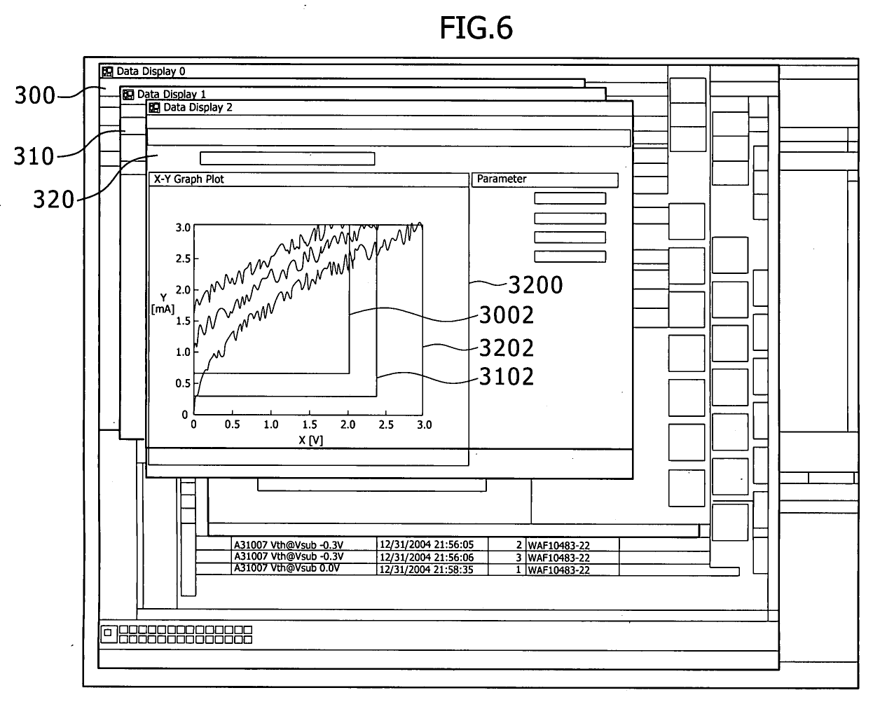

According to another embodiment, for example, the graphs in the windows can be superimposed on one another with a predetermined amount of offset. FIGS. 5 and 6 show this embodiment. Specifically, FIG. 5 shows an example of a case in which one (i.e., the window 310) of the three windows indicating the semiconductor-device measurement results is shifted by a predetermined amount of data and a portion of a display area 3102 of the graph in the window 310 is displayed in the display area 3202 of the graph in the window 320. In this case, only one graph showing a bias voltage different from the others is displayed, without superimposition, in the display area 3202 of the graph in the window 320. This arrangement provides an advantage in that a difference in behavior relative to the others can be easily confirmed. As a reference for comparison with FIG. 5, FIG. 6 shows an example of a case in which the data in the three windows shown in FIG. 5 are shifted by the same amount. In FIG. 6, a display area 3002 of the graph in the window 300 located at the bottommost layer, in addition to the graph display area 3102 shown in FIG. 5, is also displayed in the display area 3202 of the graph in the window 320. In order to ensure that icons and pictures on the display 30 do not appear in the graph display area 3202, it is preferred that the processor 40 execute processing for making areas, other than the display area 3002 of the graph in the window 300 located at the bottommost layer, opaque.

According to the embodiment (shown in FIGS. 5 and 6) in which the graphs are superimposed on one another with a predetermined amount of offset, an advantage is provided in that all behaviors of measurement results can be readily displayed in graphs for visual comparison, even when the superimposed measurement results have a certain offset.

Although a case in which one rendering unit and one window are allotted to each set of measurement result data in the embodiments described above, the present invention is not limited thereto. For example, multiple rendering unit and windows may be allotted to each set of measurement result data.

Although if the measurement results are plotted in the XY plane drawings in the embodiments described above, the present invention is not limited thereto. For example, the measurement results can be plotted and displayed in various types of graphs represented by a group of dots or lines, such as a scatter chart or a radar chart.

As described above, according to the analysis system used for implementing the present invention, measurement results can be displayed in individual windows on the display in a predetermined graph form. Some of the displayed graphs can also be selected via the input device and superimposed, with an arbitrary scale ratio, on a graph indicating a reference measurement result. In addition, autoscaling can be automatically executed so that the scales match with that of a reference graph. Furthermore, the windows can be superimposed on one another with a predetermined amount of offset.

Accordingly, the user can perform examination by arbitrarily shifting each window and comparing the superimposed state of graphs. Further, the user can perform examination by arbitrarily increasing or reducing the size of each window so as to increase or reduce the size of the corresponding graph as well as zooming, and comparing the superimposed state of the entire graph or a portion of graphs indicating measurement results. Since the above-described operations are basic operations of typical computers, the usability and operability are high.

Restrictions on the types of graphs that can be superimposed may be relaxed so that, even when the graph axes in one direction indicate the same physical quantity and the graph axes in another direction indicate different physical quantities, the graphs can still be superimposed. Alternatively, the arrangement may be such that different types of graphs can be flexibly superimposed, during operation, as the user desires.

What is claimed is:

1. An analysis system for semiconductor-device measurement results, the analysis system comprising:
a storage device for storing semiconductor-device measurement results and a graph display program;
a display for displaying the measurement results in graphs in individual windows;
input device for selecting some of the windows; and
a processor for superimposing and displaying the graphs in the windows on the display, by using the graph display program, so that only a display area of the graph in one of the windows selected by the input device, the one window being located at the topmost layer displayed by the display, is made transparent, an area other than the display area of the graph is made opaque, at least a display area of the graph located in the window displayed at the bottommost layer is made opaque, and at least a display area of the graph in the window located at a layer between the topmost layer and the bottommost layer is made transparent.

2. The analysis system according to claim 1, wherein, when the size of a first one of the graphs in the windows is changed via the input device, the processor further performs processing so that the graphs in the other windows have the same size as the first graph, based on a scale ratio of the changed first graph.

3. The analysis system according to claim 1, wherein the storage device further comprises a rendering-information sharing section that stores information on the types of graphs displayed in the selected windows.

4. The analysis system according to claim 3, wherein the type of graph is an XY plane drawing, a scatter chart, or a radar chart.

5. An analysis method for semiconductor-device measurement results, the analysis method comprising:
a storing step of storing semiconductor-device measurement results and a graph display program;
a displaying step of displaying the measurement results in graphs in individual windows;
an inputting step of selecting some of the windows; and
a computing step of superimposing and displaying the graphs in the windows, by using the graph display program, so that only a display area of the graph in one of the windows selected in the inputting step, the one window being located at the topmost layer displayed in the displaying step, is made transparent, an area other than the display area of the graph is made opaque, at least a display area of the graph located in the window displayed at the bottommost layer is made opaque, and at least a display area of the graph in the window located at a layer between the topmost layer and the bottommost layer is made transparent.

6. The analysis method according to claim 5, wherein, when the size of a first one of the graphs in the windows is changed in the inputting step, processing is performed in the computing step so that the graphs in the other windows have the same size as the first graph, based on a scale ratio of the changed first graph.

7. The analysis method according to claim 5, further comprising a step of storing, in a rendering-information sharing section, information on the types of graphs displayed in the selected windows.

8. The analysis method according to claim 5, wherein the type of graph is an XY plane graph, a scatter chart, or a radar chart.

9. A computer program for achieving an analysis method for semiconductor-device measurement results, comprising steps of: a storing step of storing semiconductor-device measurement results and a graph display program; a displaying step of displaying the measurement results in graphs in individual windows; an inputting step of selecting some of the windows; and a computing step of superimposing and displaying the graphs in the windows, by using the graph display program, so that only a display area of the graph in one of the windows selected in the inputting step, the one window being located at the topmost layer displayed in the displaying step, is made transparent, an area other than the display area of the graph is made opaque, at least a display area of the graph located in the window displayed at the bottommost layer is made opaque, and at least a display area of the graph in the window located at a layer between the topmost layer and the bottommost layer is made transparent, the program causing a processor to execute:
a command for performing processing so that only a display area of the graph in the window displayed at the topmost layer in the displaying step is made transparent and an area other than the display area is made opaque;
a command for performing processing so that at least a display area of the graph in the window displayed at the bottommost layer in the displaying step is made opaque;
a command for performing processing so that at least a display area of the graph in the window located at a layer displayed between the topmost layer and the bottommost layer in the displaying step is made transparent; and
a command for displaying, in the displaying step, the graphs in the windows and superimposing the graphs so that axes of the graphs are aligned with one another.
